(19) United States
(12) Patent Application Publication
(10) Pub. No.: US 2004/0186705 A1
(43) Pub. Date: Sep. 23, 2004

(54) Concept word management

(76) Inventors: Alexander P. Morgan, Birmingham, MI (US); John Anthony Cafeo, Farmington, MI (US); Diane I. Gibbons, Troy, MI (US); Ronald Michael Lesperance, Troy, MI (US); Gulcin Sengir, Bloomfield Hills, MI (US); Andrea Marie Simon, Walled Lake, MI (US)

Correspondence Address: KATHRYN A. MARRA, General Motors Corporation, Legal Staff, Mail Code 482-C23-B21, P.O. Box 300, Detroit, MI, 48265-3000, US

(21) Appl. No.: 10/392,341

(22) Filed: Mar. 18, 2003

(51) Int. Cl. G06F 17/27

(52) U.S. Cl. 704/9

(57) ABSTRACT

A method for concept word management. The method comprises receiving an editing request for a text document from a requestor. The editing request includes an initial phrase located in the text document. An ontology associated with the text document is searched for the initial phrase. The initial phrase is distinguished in the text document in response to the initial phrase being located in the ontology and to the editing request further including a distinguish phrase command. An alternate phrase associated with the initial phrase is presented to the requestor in response to the initial phrase being located in the ontology and to the editing request further including a display alternate phrase command. The initial phrase is replaced in the text document with the alternate phrase in response to the editing request further including a replace phrase command.

### BACKGROUND OF THE INVENTION

The present disclosure relates generally to concept word management and in particular, to a method of inserting concept words and phrases into a free text document.

In an archive of text documents, including many on-line archives and libraries, it is important to be able to retrieve desired documents without finding irrelevant documents. Often it can be difficult to isolate the relevant documents and information sources because of the lack of standardized terminology contained in documents and information sources. Many corporations, or divisions of corporations, have preferred languages, or controlled vocabularies, that consist of common terms and expressions. These common terms and expressions may be referred to as concept words and phrases. Enforcing the use of the controlled vocabulary may aid in communication and in searching for and sorting free text documents. One approach to achieving consistency in the language used in text documents is to attach semantic tags to concept words and phrases. These tags make explicit the role a word or phrase plays in the text (e.g., a zip code or a diagnostic code). Semantic tags can be implemented using an ontology modeling language such as Resource Description Framework (RDF), DARPA Agent Markup Language (DAML) or Ontology Inference Layer (OIL). An ontology can be described that includes the concept words and phrases that are included in a controlled vocabulary. The meaning of each concept word or phrase and its relationship to other concept words and phrases can be defined in the ontology. The ontology defines the vocabulary that will be utilized to group and search for text documents and information sources. However, it may be difficult to enforce the use of semantic tags and the controlled vocabulary contained in the ontology by all employees who author text documents because it may cause text creation to become cumbersome.

The ability to retrieve relevant documents and to group documents is also useful when performing searches for information on the world-wide-web. The Semantic Web is heightening the interest in ways of effectively adding semantic tags to text. The concept of the Semantic Web includes developing languages for expressing information in a format that can be processed by a machine. One of the building blocks of the Semantic Web is a common model of great generality, allowing for any prospective application to be mapped onto the model. This model can be expressed in terms of an ontology and include semantic tags that can be inserted into text documents. Again, inserting semantic tags into text documents can be time consuming and cumbersome for the author of the text.

### BRIEF DESCRIPTION OF THE INVENTION

One aspect of the invention is a method for concept word management. The method comprises receiving an editing request for a text document from a requestor. The editing request includes an initial phrase located in the text document. An ontology associated with the text document is searched for the initial phrase. The initial phrase is distinguished in the text document in response to the initial phrase being located in the ontology and to the editing request further including a distinguish phrase command. An alternate phrase associated with the initial phrase is presented to the requestor in response to the initial phrase being located in the ontology and to the editing request further including a display alternate phrase command. The initial phrase is replaced in the text document with the alternate phrase in response to the editing request further including a replace phrase command.

In another aspect, a system for concept word management comprises a network, a storage device in communication with the network, a user system in communication with the network and a host system in communication with the network. The storage device stores a text document and an ontology associated with the text document. The host system includes application software to implement a method comprising receiving an editing request via the network for the text document on from a requestor on the user system. The editing request includes an initial phrase located in the text document. The ontology is searched for the initial phrase. The initial phrase is distinguished in the text document in response to the initial phrase being located in the ontology and to the editing request further including a distinguish phrase command. An alternate phrase associated with the initial phrase is presented via the network to the requestor in response to the initial phrase being located in the ontology and to the editing request further including a display alternate phrase command. The initial phrase is replaced in the text document with the alternate phrase in response to the editing request further including a replace phrase command.

In a further aspect, a computer program product for concept word management comprises a storage medium readable by a processing circuit and storing instructions for execution by the processing circuit for performing a method comprising receiving an editing request for a text document from a requester. The editing request includes an initial phrase located in the text document. An ontology associated with the text document is searched for the initial phrase. The initial phrase is distinguished in the text document in response to the initial phrase being located in the ontology and to the editing request further including a distinguish phrase command. An alternate phrase associated with the initial phrase is presented to the requestor in response to the initial phrase being located in the ontology and to the editing request further including a display alternate phrase command. The initial phrase is replaced in the text document with the alternate phrase in response to the editing request further including a replace phrase command.

### BRIEF DESCRIPTION OF THE DRAWINGS

Referring to the exemplary drawings wherein like elements are numbered alike in the several FIGURES:

FIG. 1 is a block diagram of an exemplary system for performing concept word management;

FIG. 2 is an exemplary concept phrase ontology in a hierarchical structure;

FIG. 3 is a flow diagram of an exemplary concept word management process; and

FIG. 4 is an exemplary free text document that includes concept phrases.

### DETAILED DESCRIPTION OF THE INVENTION

A method of concept word management is presented. An embodiment of the present invention encourages, but does not enforce, the use of standard concept words and phrases (with their associated semantic tags) in a free text knowledge acquisition process. Conscientious authors can utilize an embodiment of the present invention to create strongly tagged text documents, while more hurried authors can be made aware of the degree to which their text exploits standard concept words. In addition, an embodiment of the present invention can be utilized in an editing mode, for “cleaning up” text that the original authors did not have time to standardize.

Briefly stated, the method includes accessing an ontology of concept phrases (including both single words and multiple words) specialized to the application area. The ontology includes standard concept phrases, with common synonyms, misspellings, and abbreviations for the concept phrases. Also included in the ontology are the relationships between the concept phrases made explicit by taxonomic trees of standard relationships (e.g., subsumption, part of). The concept phrases all have disambiguated meaning, that, in an exemplary embodiment, are made explicit by a specialized technical dictionary. The free text, which for example, may be a description of a technical problem and an associated solution, is entered by typing in the text. When a concept phrase is used, it is distinguished by being highlighted in a first color (e.g., blue). When a synonym, misspelling or abbreviation (referred to collectively concept phrase synonyms) associated with a concept phrase is entered, it is distinguished by being highlighted in a second color (e.g., red). The user is allowed, by a simple command, to change the phrase highlighted in the second color to its root concept phrase equivalent. This substitution can be un-done, or reversed, if the author is unhappy with it. Concept phrases are linked to their closest associates in the ontology, so that quick substitutions (e.g., a suggested generalization) can be considered, using the arrow keys to navigate the taxonomic trees of related phrases.

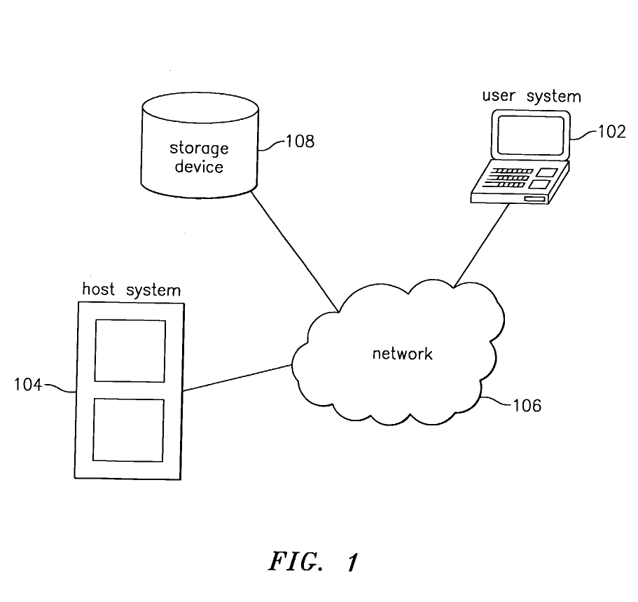

In FIG. 1, a block diagram of an exemplary system for performing concept word management is generally shown. The system includes one or more user systems 102 through which users at one or more geographic locations may contact the host system 104. In an exemplary embodiment, the host system 104 executes the concept word management application program and the user systems 102 are coupled to the host system 104 via a network 106. Each user system 102 may be implemented using a general-purpose computer executing a computer program for carrying out the processes described herein. The user systems 102 may be personal computers (e.g., a lap top, a personal digital assistant) or host attached terminals. If the user systems 102 are personal computers, the processing described herein may be shared by a user system 102 and the host system 104 (e.g., by providing an applet to the user system 102).

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A user system 102 may be coupled to the host system through multiple networks (e.g., intranet and Internet) so that not all user systems 102 are coupled to the host system 104 through the same network. One or more of the user systems 102 and the host system 104 may be connected to the network 106 in a wireless fashion. In one embodiment, the network is the Internet and one or more user systems 102 execute a user interface application (e.g. a web browser) to contact the host system 104 through the network 106 while another user system 102 is directly connected to the host system 104. In another exemplary embodiment, the user system 102 is connected directly (i.e., not through the network 106) to the host system 104 and the host system 104 is connected directly to or contains the storage device 108. In another exemplary embodiment, the user system 102 includes a stand-alone application program to perform concept word management and the application data such as the concept word ontology. In this embodiment, the application program and data are updated on a periodic basis.

The storage device 108 may be implemented using a variety of devices for storing electronic information. It is understood that the storage device 108 may be implemented using memory contained in the host system 104 or it may be a separate physical device. The storage device 108 is logically addressable as a consolidated data source across a distributed environment that includes a network 106. Information stored in the storage device 108 may be retrieved and manipulated via the host system 104. The storage device 108 includes one or more ontology databases containing concept phrases (including both single words and multiple words). The storage device 108 may also include other kinds of data such as information concerning the updating of the concept word ontology (e.g., a user identifier, date, and time of update). In an exemplary embodiment, the host system 104 operates as a database server and coordinates access to application data including data stored on storage device 108.

The host system 104 depicted in FIG. 1 may be implemented using one or more servers operating in response to a computer program stored in a storage medium accessible by the server. The host system 104 may operate as a network server (e.g., a web server) to communicate with the user system 102. The host system 104 handles sending and receiving information to and from the user system 102 and can perform associated tasks. The host system 104 may also include a firewall to prevent unauthorized access to the host system 104 and enforce any limitations on authorized access. For instance, an administrator may have access to the entire system and have authority to modify portions of the system. A firewall may be implemented using conventional hardware and/or software as is known in the art.

The host system 104 may also operate as an application server. The host system 104 executes one or more computer programs to perform concept word management functions. Processing may be shared by the user system 102 and the host system 104 by providing an application (e.g., java applet) to the user system 102. Alternatively, the user system 102 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

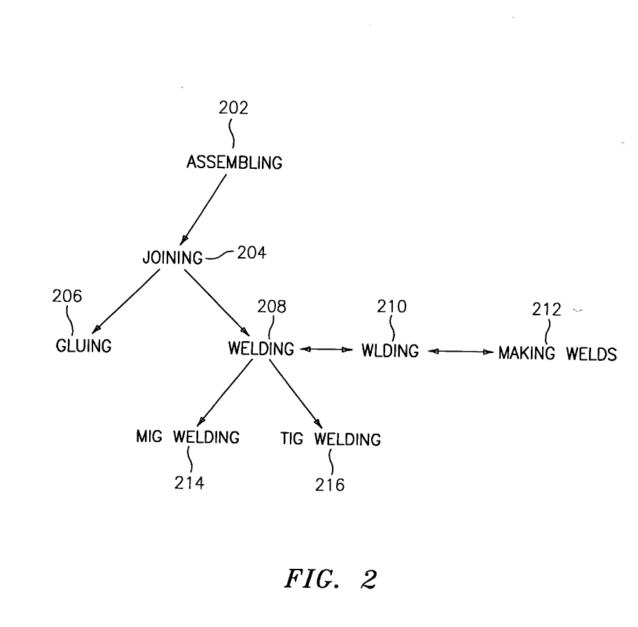

FIG. 2 is an exemplary concept phrase ontology described as a hierarchical structure. Many corporations have controlled vocabularies made up of concept phrases. By organizing the relationship between the concept phrases, a taxonomy is created. An ontology, which is a type of taxonomy, results when structure and attributes are added to the taxonomy. Each core concept phrase (not synonym) is precisely defined in an addendum to the ontology. These definitions specify the exact local (corporate) meaning of each phrase and are equivalent to semantic tags. Agents working with text supported by the ontology will be programmed to function correctly in the light of these tags, responding to the concept phrases and their relationships with a full apprehension of their meanings. Thus, an agent will know what to do when a “zip code” or a “diagnostic code” is encountered. Here, the “agent” might be a computer program or a person. The concept phrase ontology depicted in FIG. 2 includes a subset of concept phrases and concept phrase synonyms that could be utilized to describe a manufacturing process. The subset in FIG. 2 is for example purposes only, a typical concept phrase ontology would contain many more entries. The concept phrases in the ontology tree may include terms that are utilized throughout a corporation or within a division of a corporation. Standardizing the free text documents, to conform to the concept phrases in the ontology tree may lead to better communication because the concept phrases have been defined to have a standard meaning. In addition, standardizing the language in free text documents may result in the ability to more easily group related text documents by searching for the concept phrases. The concept phrase “assembling” 202 is at the top of the hierarchy. Below “assembling” 202 is the concept phrase “joining” 204. The hierarchy implies that joining 204 is one type of assembling 202. As depicted in FIG. 2, types of joining 204 include “gluing” 206 and “welding” 208. Welding 208 is a concept phrase that could be substituted for the misspelling “wlding” 210 or for the alternate phrase “making welds” 212. “Wlding” 210 and “making welds” 212 are concept phrase synonyms for “welding” 208. Below “welding” 208 are the concept phrases “MIG welding” 214 and “TIG welding” 216.

In an exemplary embodiment of the present invention, a text author may enter the initial phrase “welding” 208. Because of its location in the ontology, “welding” 208 would be tagged as a concept phrase and alternate concept phrases include the more general concept phrase “joining” 204, and the more specific concept phrases “MIG welding” 214 and “TIG welding” 216. Alternatively, the text author may enter the initial phrase “wlding” 210. Because of its location in the ontology, “wlding” 210 would be tagged as an alternate concept phrase and the associated root concept phrase would be “welding” 208. FIG. 2 depicts a hierarchical tree structure, but alternate embodiments include other structures. The “tree structure” is logical and has no geometrical or topological meaning. It could be manifested by a system of object-pointer n-tuples, where each phrase is matched with pointers to more general, less general, and synonym phrases. The ontology tree may be created using any tools known in the art and may be initially created by a team of experts and/or librarians and then updated as needed.

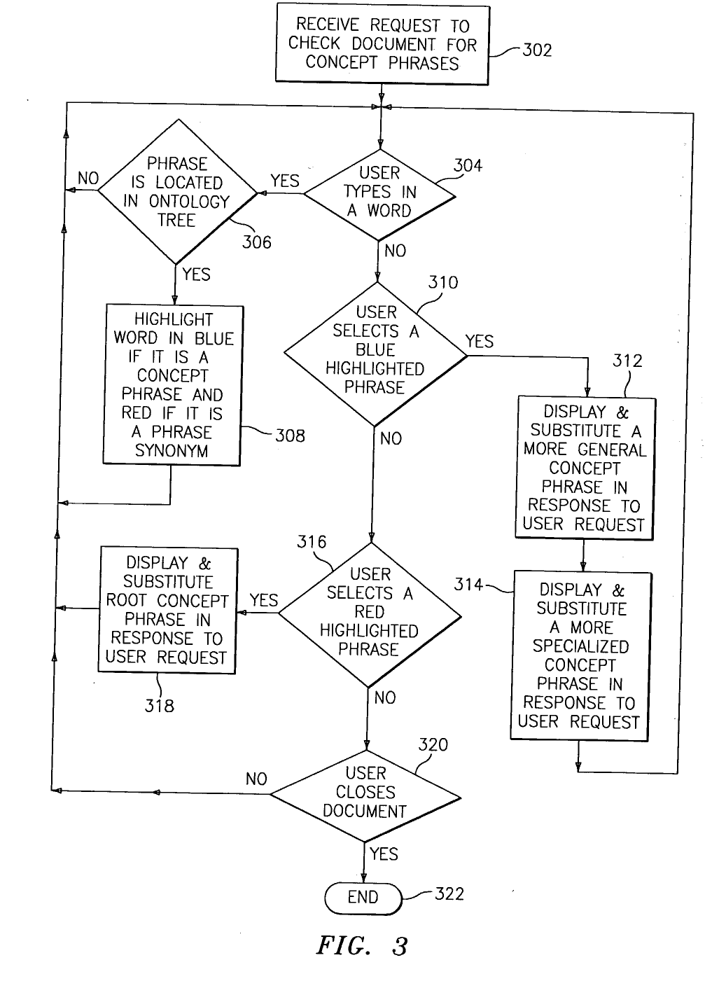

FIG. 3 is a flow diagram of an exemplary concept word management process. At step 302, a request to check a text document for concept phrases is received from a user or text author. At step 304, a check is performed to determine if the user typed in a word. If a word was typed in by the user, step 306 is performed to check the ontology tree for the word that was typed by the user. Additionally, the application program will check a pre-selected number of previously typed in words along with the word that was last typed in to determine if a phrase typed in by the user is contained in the ontology tree. In this application the term phrase refers to word strings made up of both single words and multiple words. If the phrase is included in the concept phrase ontology tree, then step 308 is performed and the phrase is distinguished by being highlighted. In an exemplary embodiment, the phrase is distinguished by being highlighted in blue if it is a concept phrase and highlighted in red if it is a concept phrase synonym. Processing then continues at step 304. Alternatively, if at step 304 it was determined that the user did not type in a word, step 310 is performed. At step 310, a check is made to determine if the user has selected a phrase that is highlighted in blue. This signifies that the user has selected a concept phrase in the document. If the user has selected a concept phrase, step 312 is performed. At step 312 an alternate concept phrase that is a more general concept phrase is displayed in response to user selection (e.g., pressing an up-arrow key) and then substituted in response to user selection (e.g., selecting a substitute icon). A notification will be displayed if the user is already at the top of the heierarchy (i.e., at “assembling” 202). Next, step 314 is performed and an alternate concept phrase that is a more specialized concept phrase is displayed in response to user selection (e.g., pressing a down-arrow key) and then substituted in response to user selection (e.g., selecting a substitute icon). A notification will be displayed if the user is already at the bottom of the heierarchy (e.g., at “gluing” 206″). Processing then continues at step 304.

Next, as depicted in FIG. 3, if the user has not selected a blue highlighted phrase at step 310, step 316 is performed. At step 316, a check is made to determine if the user has selected a phrase that is highlighted in red. This signifies that the user has selected a concept phrase synonym in the document. If the user has selected a concept phrase synonym, step 318 is performed. At step 318, the root concept phrase associated with the concept phrase synonym is displayed in response to user selection (e.g., pressing a right-arrow key) and then substituted in response to user selection (e.g., selecting a substitute icon). Processing then continues at step 304. Next, if the user has not selected a red highlighted phrase at step 316, step 320 is performed. At step 320, a check is made to determine if the user has closed the document. If the user has closed the document, step 322 is performed and the application program is ended. If the user has not closed the document, as determined at step 320, processing continues at step 304. The concept word management application program continues until the user closes the document.

The processing described in FIG. 3 can be performed along with standard word processing functions such as spell check and grammar check. The processing described may be implemented as a subroutine that is invoked by an existing word processing application program and therefore standard word processing functions can also be performed on the document while concept word management functions are being performed. In an embodiment of the present invention, phrases within the ontology tree may be distinguished from other text by presenting the phrases in any manner that a user would recognize as a differentiation. For example, different fonts and different colors are two such manners of distinguishing an ontology tree phrase and whether it is a concept phrase or a concept phrase synonym.

In an embodiment of the present invention, the user may select a specific concept phrase ontology tree to apply to the text document that is being edited. In this manner, a number of ontology trees could be utilized. For example, one ontology tree may contain concept phrases that are utilized in text documents that are circulated within a corporation. It could include jargon that would be difficult to understand by individuals not employed by the corporation. Another ontology tree may include concept phrases that have universal meaning and that are utilized in text documents that are circulated outside of the corporation (e.g., to clients, press releases). An embodiment of the present invention could be utilized to create either of these types of text documents and to convert between the two types of text documents.

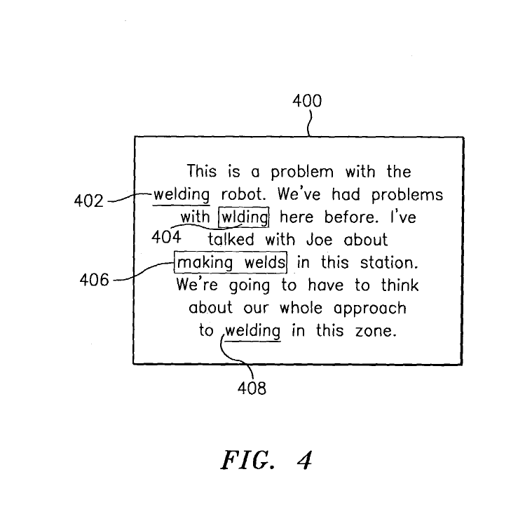

FIG. 4 is an exemplary free text document 400 that includes concept phrases and concept phrase synonyms. In an exemplary embodiment, checking the document for concept phrases and concept phrase synonyms can be performed either in a batch mode, with the results presented to the user or the checking can be performed while the user is entering the text data. The free text document 400 depicted in FIG. 4 has been checked for concept phrases and concept phrase synonyms in a batch mode and the results are being presented to the user for further editing. The document 400 describes a problem involving a welding robot. In an exemplary embodiment, the phrase “welding” 402, 408 would be distinguished by being highlighted in blue to signify that it is a concept phrase contained in the ontology. The user could select the first occurrence of “welding” 402 and then choose to view the more general concept phrase associated with the word “welding” (e.g., by pressing the up-arrow key). Referring to the ontology tree depicted in FIG. 2, this would result in the phrase “joining” 204 being displayed on the computer screen. The user could then choose to substitute the phrase “joining” 204 in the document 400 in place of the phrase “welding” 402 (e.g., by selecting a “substitute” icon). Alternatively, the user could continue to navigate through the ontology tree, by either moving to the more general concept phrase “assembling” 202 or to a more specialized concept phrase such as “gluing” 206. Similarly, the user could choose to view more specialized concept phrases associated with the phrase “welding” (e.g., by pressing the down-arrow key). Referring to the ontology tree depicted in FIG. 2, this would result in the phrases “MIG welding” 214 and “TIG welding” 216 being displayed on the computer screen. The user could then choose to substitute either of these phrases in the document 400 in place of the phrase “welding” 402. Alternatively, the user could choose to leave the phrase “welding” 402 alone, either before or after viewing substitution choices, or the user may choose to put back the phrase “welding” 402 after making a substitution. The same choices for substitution would be made available in response to the user selecting the second occurrence of “welding” 408 in the document 400. It is not necessary that both occurrences of “welding” 402, 408 result in the same substitutions, for example, the first occurrence could be left as “welding” 402 and the second occurrence of “welding” 408 could be changed to “joining” 204.

Referring to FIG. 4, the phrase “wlding” 404 and the phrase “making welds” 406 would be distinguished by being highlighted in red to signify that they are concept phrase synonyms. The user could select “wlding” 404 and then choose to view the root concept phrase (e.g., by pressing the right-arrow key). Referring to the ontology tree depicted in FIG. 2, this would result in the concept phrase “welding” 208 being displayed on the computer screen. The user could then choose to substitute the phrase “welding” 208 in the document 400 in place of the phrase “wlding” 404 (e.g., selecting a “substitute” icon). The substituted phrase “welding” 208 would be highlighted in blue and the viewing and the substituting process described above may be performed on the substituted phrase. The same processing applies to the phrase “making welds” 212. In the manner described above in reference to FIG. 4, the user can move through the ontology tree and determine what phrase best fits the context of the document.

The disclosed invention provides an unobtrusive form of semantic tagging. It allows for flexible use so that one user can exploit its features aggressively, while another can enter his text without the tool intruding on the text entry process. In a manufacturing context, an embodiment of the present invention may be utilized by engineers entering text who do not always have the time or motivation to bother much with “cleaning up” their text to conform to a corporate ontology, as well as other authors that may include a more dedicated subset of engineers motivated to utilize corporate concept words and phrases. In addition, an embodiment of the present invention can be utilized to improve the knowledge content of text documents. It provides a convenient tool for semantic markup of text for standardizing the language of text, and for making text more general or specific in a controlled manner. It can also offer foreign language indexing for key concept words. Text that has been standardized and semantically tagged can be used more effectively, especially for search, consolidation, fusing and knowledge extraction/summarization.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for concept word management, said method comprising:
receiving an editing request for a text document from a requester, said editing request including an initial phrase located in said text document;
searching an ontology associated with said text document for said initial phrase;
distinguishing said initial phrase in said text document in response to said initial phrase being located in said ontology and to said editing request further including a distinguish phrase command;
presenting an alternate phrase associated with said initial phrase to said requestor in response to said initial phrase being located in said ontology and to said editing request further including a display alternate phrase command; and
replacing said initial phrase in said text document with said alternate phrase in response to said editing request further including a replace phrase command.

2. The method of claim 1 wherein said presenting includes displaying said alternate phrase on a computer screen.

3. The method of claim 1 further comprising presenting said text document to said requestor.

4. The method of claim 1 wherein said distinguishing further comprises distinguishing said initial phrase in a first manner if said initial phrase is a concept phrase and distinguishing said initial phrase in a second manner if said initial phrase is a concept phrase synonym.

5. The method of claim 4 wherein said first manner includes changing the color of said initial phrase to blue and said second manner includes changing the color of said initial phrase to red.

6. The method of claim 1 wherein said initial phrase consists of a single word.

7. The method of claim 1 wherein said initial phrase includes multiple words.

8. The method of claim 1 further comprising categorizing said initial phrase based on the results of said searching, wherein said initial phrase is categorized as a concept phrase or a concept phrase synonym in response to locating said initial phrase in said ontology and to the placement of said initial phrase in said ontology.

9. The method of claim 8 wherein:
said alternate phrase is a more general concept phrase then said initial phrase in response to said initial phrase being categorized as a concept phrase and to said alternate phrase command including a generalization command;
said alternate phrase is a more specialized concept phrase than said initial phrase in response to said initial phrase being categorized as a concept phrase and to said alternate phrase command including a specialization command; or
said alternate phrase is a root concept phrase in response to said initial phrase being categorized as a concept phrase synonym and to said alternate phrase command including a root phrase command.

10. The method of claim 9 wherein said generalization command is indicated by pressing an up-arrow key on a key-pad.

11. The method of claim 9 wherein said specialization command is indicated by pressing a down-arrow key on a key-pad.

12. The method of claim 9 wherein said root phrase command is indicated by pressing a right-arrow key on a key-pad.

13. The method of claim 9 wherein said concept phrase synonym includes synonyms, misspellings and abbreviations associated with said root concept phrase.

14. The method of claim 1 wherein said ontology has a hierarchical structure.

15. The method of claim 1 wherein said ontology includes semantic tags.

16. The method of claim 1 wherein said method is performed in an interactive mode.

17. The method of claim 1 wherein said method is performed in a batch mode.

18. The method of claim 1 wherein said text document is a free-text document.

19. A system for concept word management, the system comprising:
a network;
a storage device in communication with said network, said storage device storing a text document and an ontology associated with said text document;
a user system in communication with said network; and
a host system in communication with said network, said host system including application software to implement a method comprising:
receiving an editing request via said network for said text document from a requestor on the user system, said editing request including an initial phrase located in said text document;
searching said ontology for said initial phrase;
distinguishing said initial phrase in said text document in response to said initial phrase being located in said ontology and to said editing request further including a distinguish phrase command;
presenting an alternate phrase associated with said initial phrase via said network to said requester in response to said initial phrase being located in said ontology and to said editing request further including a display alternate phrase command; and
replacing said initial phrase in said text document with said alternate phrase in response to said editing request further including a replace phrase command.

20. The system of claim 19 wherein said user system and said host system are located in different geographic locations.

21. The system of claim 19 wherein said host system and said storage device are located in different geographic locations.

22. The system of claim 19 wherein said network, said storage device, said user system and said host system are located in the same physical hardware.

23. The system of claim 19 wherein said network is the Internet.

24. A computer program product for concept word management, the computer program product comprising:
a storage medium readable by a processing circuit and storing instructions for execution by the processing circuit for performing a method comprising:
receiving an editing request for a text document from a requester, said editing request including an initial phrase located in said text document;
searching an ontology associated with said text document for said initial phrase;
distinguishing said initial phrase in said text document in response to said initial phrase being located in said ontology and to said editing request further including a distinguish phrase command;
presenting an alternate phrase associated with said initial phrase to said requester in response to said initial phrase being located in said ontology and to said editing request further including a display alternate phrase command; and
replacing said initial phrase in said text document with said alternate phrase in response to said editing request further including a replace phrase command.
